(19) United States
(12) Patent Application Publication
(10) Pub. No.: US 2015/0351439 A1
(43) Pub. Date: Dec. 10, 2015

(54) YEAST CELL WALLS COMPRISING VITAMIN D2, USES THEREOF AND METHOD OF PRODUCING THE SAME

(71) Applicant: DANSTAR FERMENT A.G., Zug (CH)

(72) Inventors: Richard Degre, St. Bruno (CA); Zhigen Zhang, Montreal (CA)

(21) Appl. No.: 14/760,772

(22) PCT Filed: Jan. 24, 2013
(86) PCT No.: PCT/EP13/51385

§ 371 Date: Jul. 14, 2015

(51) Int. Cl. A23L 1/30; A23L 2/52; A23L 1/303; A21D 2/14; A23K 1/16; A23K 1/18

(52) U.S. Cl. CPC A23L 1/3018; A23K 1/1603; A23K 1/1826; A23L 1/303; A21D 2/14; A23L 2/52

(57) ABSTRACT

There is provided yeast cell walls comprising vitamin D2. The vitamin D may be added vitamin D2 or obtained by treatment of a yeast cells walls fraction with UV light or by treatment of a yeast with UV light followed by autolysis and/or hydrolysis and separation. There is also provided uses of the yeast cell walls.

### FIELD OF THE INVENTION

The present application relates to auxiliary sources of vitamin D for human and animal applications. More particularly, the present application relates to yeast cell walls comprising vitamin D2, uses thereof and methods of producing the same.

### BACKGROUND OF THE INVENTION

Yeast such as Saccharomyces is known to have a high nutritional value, in particular as a source of vitamin B. Brewer's yeast for example has been sold commercially as a human supplement for years. Other yeasts like Torula, Candida or Klyuveromyces have also been used as nutritional supplements of growth factors and vitamins for human use and/or animal feed. More recently, the interest for yeast comprising vitamin D used to fortify foods for human and animal applications is growing in popularity. Yeast, however, does not contain vitamin D but a unique sterol, ergosterol, which is a provitamin D2 sterol. Yeast comprising vitamin D is usually obtained by treating the yeast with a UV source.

### SUMMARY OF THE INVENTION

In accordance with an aspect of the invention, there is provided yeast cell walls comprising vitamin D2.

In one aspect of the yeast cell walls, the vitamin D2 is added vitamin D2.

In another aspect of the yeast cell walls, the vitamin D2 is obtained by treating a yeast or a yeast cell walls fraction with a UV source.

In a further aspect of the yeast cell walls, the yeast cell walls are UV treated.

In one aspect of the yeast cell walls comprising vitamin D2, the yeast cell walls are produced from a Saccharomyces or any non-Saccharomyces yeast.

In another aspect of the non-Saccharomyces yeast is selected from the group consisting of Candida sp, Hanseniaspora sp, Hansenula sp, Kluyveromyces sp, Metschnikowia sp, Pichia sp, Starmerella sp and Torulaspora sp.

In an aspect of the UV treated yeast cell walls comprising vitamin D2, the UV treated yeast cell walls comprise β-glucan,

In an aspect of the UV treated yeast cell walls comprising vitamin D2, the β-glucan content is at least 75% of the β-glucan content of yeast cell walls untreated with UV light, at least 80% of the β-glucan content of yeast cell walls untreated with UV light, at least 85% of the β-glucan content of yeast cell walls untreated with UV light or at least 90% of the β-glucan content of yeast cell walls untreated with UV light.

In accordance with another aspect of the invention, yeast cell walls or UV treated yeast cell walls as defined above are used as a dietary supplement for animal or human nutrition.

In accordance with a further aspect of the invention, there is provided a use of yeast cell walls or UV treated yeast cell walls as defined above as additives for baked goods, functional food, dietary food, nutritional food, fermented or non-fermented beverage.

In accordance with a yet further aspect of the invention, there is provided a baked good produced using yeast cell walls or UV treated yeast cell walls as defined above.

In one aspect of the baked good, the baked good is bread, crackers, sport bars or biscuits.

In accordance with another aspect of the invention, there is provided a composition comprising an animal feed and UV treated yeast cell walls comprising vitamin D2.

In an aspect of the composition, the composition is used in the diet of layer chickens to increase vitamin D2 content in egg yolk.

In accordance with yet a further aspect of the invention there is provided a method of increasing vitamin D2 content in egg yolk comprising feeding a composition comprising a layer chickens feed and UV treated yeast cell walls comprising vitamin D2 to layer chickens.

In accordance with another aspect of the invention, there is provided a method for preparing UV treated yeast cell walls comprising vitamin D2, the method comprising the steps of providing a yeast; autolysing and/or hydrolysing the yeast to obtain an autolysed and/or hydrolysed yeast; separating the autolysed and/or hydrolysed yeast to provide a yeast cell walls fraction and yeast extract; and treating the yeast cell walls fraction with UV light to obtain the UV treated yeast cell walls comprising vitamin D2.

In an aspect of the method, the vitamin D2 content is at least 100 fold higher than yeast cell walls untreated with UV light, least 200 fold higher than yeast cell walls untreated with UV light, at least 300 fold higher than yeast cell walls untreated with UV light, at least 400 fold higher than yeast cell walls untreated with UV light, at least 500 fold higher than yeast cell walls untreated with UV light, at least 1000 fold higher than yeast cell walls untreated with UV light, at least 5000 fold higher than yeast cell walls untreated with UV light or at least 10000 fold higher than yeast cell walls untreated with UV light.

In accordance with a further aspect of the invention, there is provided a method for preparing UV treated yeast cell walls comprising vitamin D, the method comprising the steps of: providing a yeast; treating the yeast with UV light to obtain a UV treated yeast comprising vitamin D2; autolysing and/or hydrolysing the UV treated yeast comprising vitamin D2 to obtain a UV treated autolysed and/or hydrolysed yeast; and separating the UV treated autolysed and/or hydrolysed yeast to provide a UV treated yeast cell walls fraction comprising vitamin D2 and a UV treated yeast extract.

In an aspect of the method, the vitamin D2 content in the UV treated yeast cell walls is at least 1.25-fold, preferably at least 1.5-fold, more preferably at least 1.75-fold and most preferably at least 2-fold the content of vitamin D2 in the UV treated yeast comprising vitamin D2.

### DESCRIPTION OF THE DRAWINGS

FIG. 1 illustrates a surface UV photo-bioreactor used for the UV treatment of yeast cell wall in accordance with an embodiment of the invention;

FIG. 2 illustrates a submerged UV photo-bioreactor for the UV treatment of yeast cell wall for volumes up to 20 L in accordance with another embodiment of the invention;

FIG. 3 illustrates a method for producing UV treated yeast cell walls comprising vitamin D2 in accordance with an embodiment of the invention;

FIG. 4 illustrates an alternate method for producing UV treated yeast cell walls comprising vitamin D2 in accordance with another embodiment of the invention; and

FIG. 5 illustrates the β-glucans content in yeast cell walls before and after treatment with UV light in accordance with an embodiment of the invention.

### DETAILED DESCRIPTION

Vitamin D plays an essential role in the health of both humans and animals. Humans are capable of producing vitamin D, specifically vitamin D3, when exposed to UV radiations from sunlight. Also, vitamin D is available through the diet, specifically vitamin D fortified milk. With individuals spending less time in direct sun exposure and consuming less milk, especially amongst adults, these sources of vitamin D have become insufficient to provide for the vitamin D levels necessary for good health.

Fortified breads and cereals, for example, have been an auxiliary source of vitamin D in the diet. However, commercially available vitamin D3 used as an additive is isolated from animal sources by extraction and purification steps, making it an unacceptable additive for at least a portion of the population.

Accepted alternative sources of vitamin D can be found in yeasts. However, yeasts do not include vitamin D but a unique sterol, ergosterol, which is a provitamin D2 sterol. One of the methods known for increasing vitamin D, for example in breads made of yeast containing ergosterol, requires bakers to treat the breads with UV light. Other methods known for increasing vitamin D generally involved the UV treatment of an active yeast at low temperature to avoid autolysis of the yeast, thereby preserving the yeast viability, the enzyme activity and the vitamin D content.

It was observed that the ergosterol is predominantly partitioned into the yeast cell walls by product after the autolysis and/or hydrolysis and separation process of the yeast. It was found that ergosterol remains stable under the autolysis and/or hydrolysis and separation process of the yeast, and retain most of its capacity to be converted to vitamin D2. As a result, higher ergosterol content convertible to vitamin D2 with UV light may be obtained in the yeast cell walls by-product. This was found advantageous for providing humans and animals with vitamin D levels necessary for good health. This was also found advantageous for providing humans and animals with an inexpensive auxiliary source of vitamin D not isolated from animal sources. This was further found advantageous for providing humans and animals with added-value foods and feed additive and added-value baked goods.

The present application relates to yeast cell walls comprising vitamin D2, uses thereof and methods of producing the same

The term “yeast cell walls” when used herein will be understood to refer to a by-product obtained by autolysis and/or hydrolysis of yeast. Within the process the insoluble cell walls are separated from the soluble components (yeast extract). The yeast cell walls are mainly composed of β-glucans, mannoproteins and proteins. As mentioned above, ergosterol is predominantly partitioned into the yeast cell walls after the autolysis and/or hydrolysis of yeast.

The term “UV treated” or “treated with UV light” when used herein will be understood to refer to the process by which the yeast cell walls or the yeast have been exposed or are exposed to UV light for the purpose of increasing the vitamin D2 content therein.

The term “UV treated yeast cell walls comprising vitamin D” when used herein will be understood to refer to the yeast cell walls mentioned above in which the content of vitamin D2 has been increased in response to a treatment with UV light.

Reference will now be made to the embodiments illustrated in the drawings and described herein. It is understood that no limitation of the scope of the disclosure is thereby intended. It is further understood that the present disclosure includes any alterations and modifications to the illustrated embodiments and includes further applications of the principles of the disclosure as would normally occur to one skilled in the art to which this disclosure pertains.

In an embodiment, yeast cell walls comprising vitamin D2 is provided. The vitamin D2 may be added vitamin D2. The added vitamin D2 may be obtained from any suitable source for the purpose of the present application and mixed with the yeast cell walls.

In another embodiment, the cell walls comprising vitamin D2 are UV treated yeast cell walls comprising vitamin D2. Methods for obtaining the UV treated yeast cell walls comprising vitamin D2 are also provided.

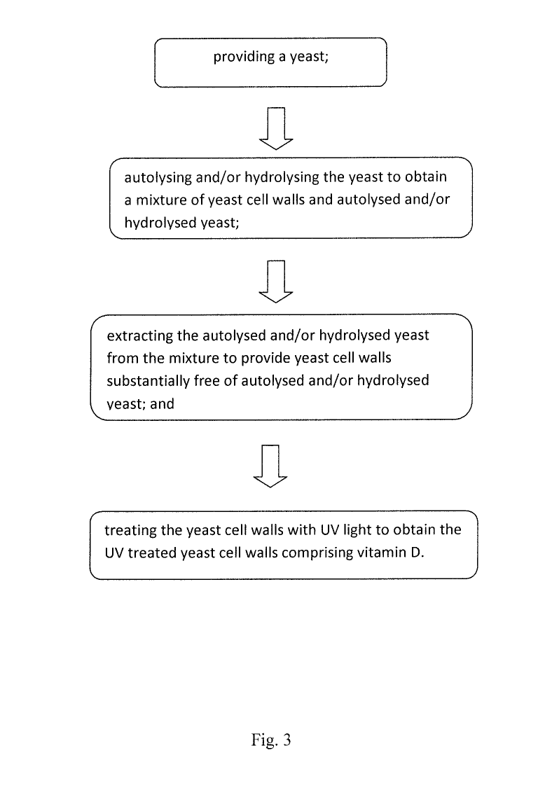

Referring to FIG. 3, a method 10 for preparing UV treated yeast cell walls comprising vitamin D2 in accordance with the present application is shown. In step 20, the method 10 comprises providing a yeast. The yeast may be a yeast from the genus Saccharomyces or any non-Saccharomyces yeast. The non-Saccharomyces yeast is selected from the group consisting of Candida sp, Hanseniaspora sp, Hansenula sp, Kluyveromyces sp, Metschnikowia sp, Pichia sp, Starmerella sp and Torulaspora sp. Preferably, the yeast is Saccharomyces cerevisae or Cyberlindnera jadinii (Torula yeast).

In step 22, the yeast of step 20 is subject to autolysis and/or hydrolysis in accordance with methods known to the skilled practitioner, to obtain an autolysed and/or hydrolysed yeast. In an embodiment, at least one enzyme may be used for the hydrolysis of the yeast. Preferably the at least one enzyme is papaine. It is understood that other suitable enzymes or enzymes mixtures for the purpose of hydrolysing yeast may be used. In one embodiment, the autolysis and/or hydrolysis may be made at a temperature between 50 and 65° C., preferentially between 55 and 60° C., and for a period of, for example, 20 to 28 hours, preferentially 22 to 24 hours.

The autolysed and/or hydrolysed yeast of step 22 may be deactivated by heat treatment, with methods known to the skilled practitioner, at a temperature between 75 and 85° C. for 15 to 30 minutes.

In step 24, the autolysed and/or hydrolysed yeast of step 22 is separated to provide a yeast cell walls fraction and a yeast extract. More specifically; the soluble fraction of (the yeast extract) is separated from the insoluble portion (the yeast cell walls fraction) according to method known to the skilled practitioner by using, for example, a centrifugal separator. It is understood that any other suitable method for separating the soluble fraction from the insoluble fraction may be used. The yeast extract which does not form part of the present application may however be used in other suitable applications such as, for example, for producing food, wine, beer and fuel ethanol.

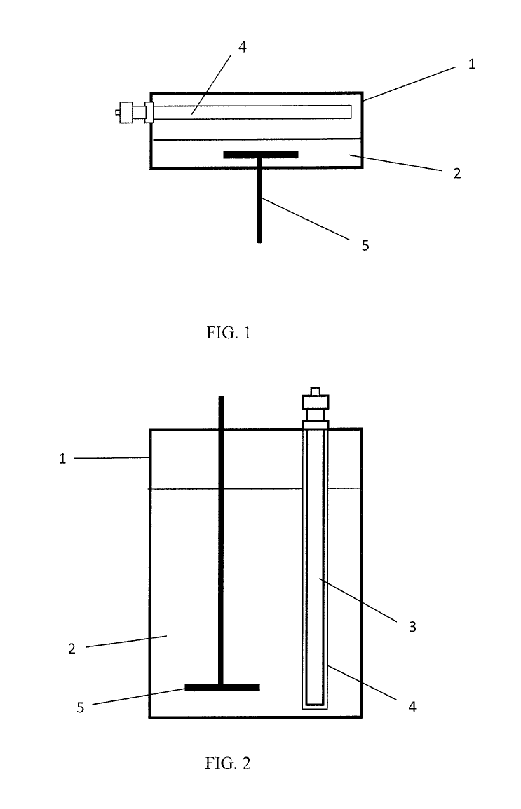

In step 26, the liquid yeast cell walls fraction obtained from step 24 is treated with UV light to increase the content of vitamin D2 therein to produce UV treated yeast cell walls comprising vitamin D2. To increase the content of vitamin D2 in the yeast cell walls, the yeast cell walls fraction of step 24 may be treated with UV light in a UV photo-bioreactor system with agitation as illustrated in FIG. 1 or FIG. 2. At small scale, for example, the laboratory scale, the yeast cell walls fraction may be treated with UV light in the surface UV photo-bioreactor of FIG. 2. for a period of about 2 to 6 hours, preferably about 4 hours. The yeast cell walls fraction obtained from step 24 may be treated with UV light at a temperature between about 4° C. and about 60° C., preferably about 50° C. In another embodiment of, the UV light may be positioned at a distance of 2.5 to 10 cm from the surface of the treated yeast cell walls.

Alternatively, for larger scale, the yeast cell walls fraction obtained from step 24 may be treated with UV light in a submerged photo-bioreactor as illustrated in FIG. 2, for longer period such as, for example, 24 to 120 hours. It is understood that the treatment of the yeast cell walls fraction with UV light may require, as needed, shorter or longer period of time. At larger scale, the yeast cell walls may be treated with UV light at a temperature between about 4° C. and about 60° C., preferably at a temperature of about 4° C. In one embodiment, the UV light may be submerged in a photo-bioreactor.

In one embodiment, the wavelength of the UV light may be in the range 200-400 nm, preferably in the UVB band, more specifically at 302 nm, or preferably in the UVC band, more specifically at 254 nm.

The corresponding UV treated liquid yeast cell wall comprising vitamin D2 from step 26 may be further concentrated and spray-dried to obtain a powder of UV treated yeast cell wall comprising vitamin D2. It is understood that other suitable method such as, for example roller drying may be used for the purpose of obtaining dry UV treated yeast cell walls comprising vitamin D2.

In an embodiment of method 10, the content of vitamin D2 in said UV treated yeast cell walls is increased at least 50-fold, and more preferably at least 100-fold, at least 200-fold, at least 300-fold, at least 400-fold, at least 500-fold, at least 1000-fold, at least 5000-fold and at least 10000-fold when compared to non-UV treated yeast cell walls.

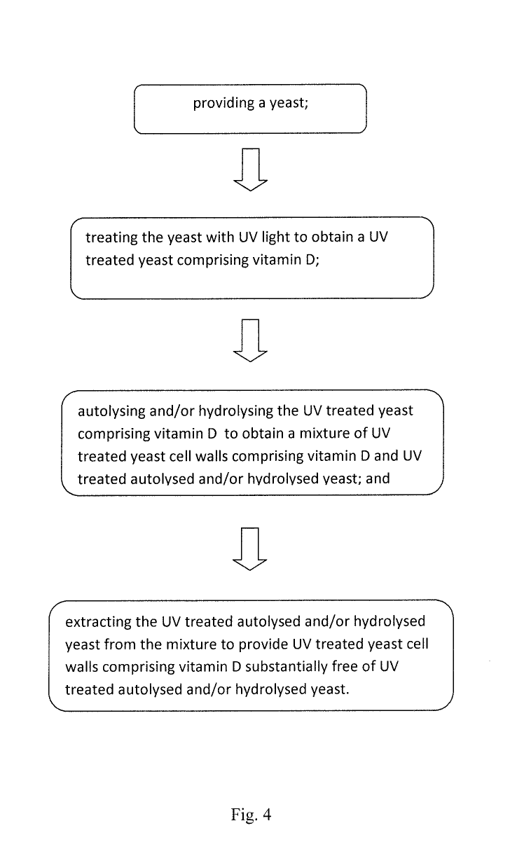

Referring to FIG. 4, an alternate method 110 for preparing UV treated yeast cell walls comprising vitamin D in accordance with the present application is shown. In step 120, the method 110 comprises providing a yeast. The yeast is as defined above in the description of method 10.

In step 122, the yeast of step 120 is treated with UV light to obtain a UV treated yeast comprising vitamin D2. The yeast is subject to the same conditions of UV light, time and temperature as defined above in the description of the method 10.

In step 124, the UV treated yeast comprising vitamin D2 obtained in step 122 is subject to an autolysis and/or hydrolysis in accordance with methods known to the skilled practitioner, to obtain an autolysed and/or hydrolysed UV treated yeast comprising vitamin D2. In an embodiment, at least one enzyme may be used for the hydrolysis of the UV treated yeast. Preferably, the at least one enzyme is papaine. It is understood that other suitable enzymes or enzymes mixtures for the purpose of autolysing/hydrolysing yeast may be used. In one embodiment, the autolysis/hydrolysis may be made at a temperature between 50 and 65° C., preferentially between 55 and 60° C., and for a period of for example, 20 to 28 hours, preferentially 22 to 24 hours.

The autolysed and/or hydrolysed UV treated yeast comprising vitamin D2 obtained from step 124 may be deactivated by heat treatment, with methods known to the skilled practitioner, at a temperature between 75 and 85° C. for 15 to 30 minutes.

In step 126, the autolysed and/or hydrolysed UV treated yeast is separated to provide a UV treated yeast cell walls fraction comprising vitamin D2 and a yeast extract. More specifically; the soluble fraction of (the yeast extract) is separated from the insoluble portion (the UV treated yeast cell walls fraction comprising vitamin D2) according to the same suitable method as defined in method 10. The yeast extract which does not form part of the present application may however be used in other suitable applications as defined in method 10.

The corresponding UV treated liquid yeast cell walls fraction comprising vitamin D2 from step 126 may be further concentrated and spray-dried to obtain a powder of UV treated yeast cell wall comprising vitamin D2. It is understood that other suitable method such as, for example roller drying may be used for the purpose of obtaining dry UV treated yeast cell walls comprising vitamin D2.

In an embodiment of the method 110, the percentage of vitamin D2 in the UV treated commercial liquid yeast that is partitioned into yeast cell walls after the autolysis/hydrolysis and fractionation steps is at least 75% and more preferably at least 80%, at least 85%, at least 90% and at least 95%. Depending on the yield of the separation step, the vitamin D2 content in the UV treated yeast cell walls is at least 1.25-fold, preferably at least 1.5-fold, more preferably at least 1.75-fold and most preferably at least 2-fold the vitamin D2 the content in the UV treated yeast comprising vitamin D2.

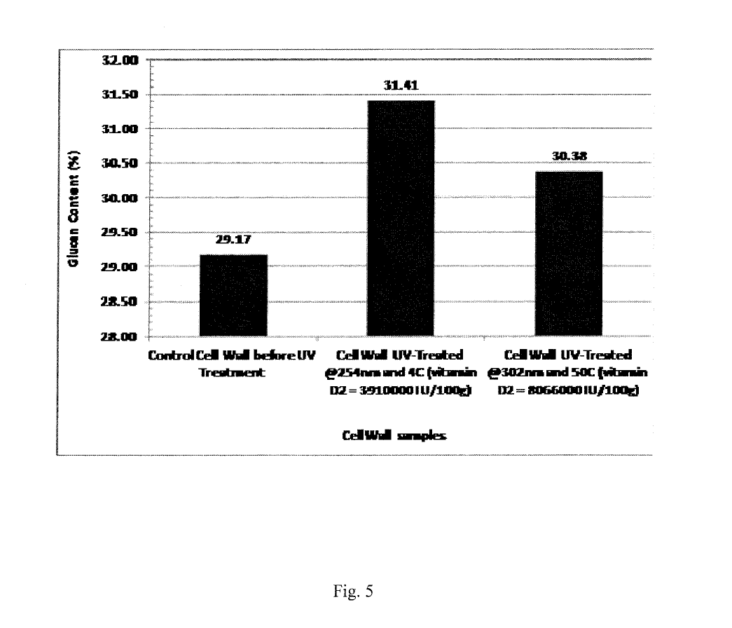

In one embodiment, the UV treated yeast cell walls further comprises β-glucans which are also known to have many health benefits to humans and animals. As shown in FIG. 5 the β-glucans content in the yeast cell walls measured before and after treatment with UV light at different wavelengths and temperatures are very similar to each other. The yeast cell walls before treatment with UV light has a β-glucan content of 29.17 weight % relative to the total weight of the yeast cell walls on a dry basis. The yeast cell walls treated with UV light at 254 nm and at 4° C. has a β-glucan content of 31.41 weight % relative to the total weight of the yeast cell walls on a dry basis. The yeast cell walls treated with UV light at 302 nm and at 50° C. has a β-glucan content of 30.38 weight % relative to the total weight of the yeast cell walls on a dry basis. With reference to these results, it is concluded therefrom that the UV treated yeast cell walls comprising vitamin D2 retain most of its β-glucan content after the UV light treatment regardless of the conditions. More specifically, UV treated yeast cell walls comprising vitamin D2 may retain at least 75%, at least 80%, at least 85%, at least 90% or at least 95% of its β- glucan content compared to non-UV treated yeast cell wall.

In an embodiment, a composition comprising an animal feed and UV treated yeast cell walls comprising vitamin D2 is provided. The composition may further comprise β-glucans. The composition may be used in the diet of layer chickens to increase the vitamin D2 content in egg yolk. It is understood that the composition may also be use in the diet of animals as a dietary supplement. In an embodiment, the animals may be bovine, porcine, avian, equine, ovine, lapine, caprine, dogs and cats. Preferably, the avian are chicken, turkey, duck, goose, pheasant, quail or companion birds.

In another embodiment, there is provided a method for increasing vitamin D content in egg yolk comprising feeding a composition comprising a layer chickens feed and UV treated yeast cell walls comprising vitamin D to layer chickens.

In one embodiment, the UV treated yeast cell walls comprising vitamin D2 may be used as additives for baked goods, functional food, dietary food, nutraceutical food, fermented or non-fermented beverage. The UV treated yeast cell walls may further comprise β-glucans.

In one embodiment, there is provided a baked good produced using UV treated yeast cell walls comprising vitamin D2. The UV treated yeast cell walls may further comprise β-glucans. Preferably, the baked good is bread, crackers, sport bars or biscuits.

In one embodiment, there is provided goods comprising vitamin D2 for human nutrition with vitamin D2 content compatible with the regulatory requirements of daily vitamin D uptake from the diet.

In one embodiment, the UV treated yeast cell walls may be used as a nutrient or vitamin source in fermented beverages and fermented foods.

### EXAMPLES

### Equipment

For the purpose of evaluating the increase of vitamin D2 in yeast cell walls by ultraviolet treatment, the photo-bioreactors of FIG. 1 and FIG. 2 were used. The bioreactor 1 comprises a liquid solution containing the yeast material 2 of volume V1 that is not in direct contact with the ultraviolet lamp 3 positioned at a distance of 5 cm from the solution surface (FIG. 1). Alternatively, the bioreactor 1 comprises a liquid solution 2 of volume V2>V1 in which the ultraviolet lamp 3 is inserted into the solution with a quartz sleeve 4 (FIG. 2). To ensure the homogenization of the solution during treatment an agitator 5 is used.

### Example 1

### Autolysis/Hydrolysis and Yeast Fractionation

Yeast cell walls and yeast extract were produced from Saccharomyces cerevisiae using an enzyme-enhanced autolysis/hydrolysis process. The regular commercial baker's yeast cream was used and the solids content of the cream yeast was adjusted to 14.99% before the fractionation experiments. 6 liters of liquid yeast was hydrolyzed in a Chemap fermenter for 22 h at 55° C., with a pH of 5.6 and an agitation of 600 rpm. Papain (Promod 144GL from Biocatalysis) was added at a rate of 0.5% based on dry matter content of liquid yeast. After the 22h autolysis/hydrolysis, the hydrolysate was then inactivated by heat treatment at 85° C. for 30 min. After cooling of the yeast hydrolysate, separation was conducted using a laboratory centrifuge (Sorvall Legend XTR, Thermo Scientific, 10000 g) to wash and harvest the yeast cell walls fraction. The weight of liquid cell walls and liquid yeast extract were measured. Dry weight analyses (solids content) were conducted with the following three samples in order to make mass balance analysis: liquid yeast sample at the beginning of hydrolysis, hydrolyzed yeast sample after the heat inactivation treatment following hydrolysis and final liquid yeast cell walls sample.

After separation, dry cell walls samples were prepared from the liquid cell walls. For preparing dry cell walls samples, liquid cell walls were filtered or centrifuged and pressed to make a cell walls cake. The cake was then dried in the oven at 85° C. for 4 to 5 hours and the dried cell walls were then grounded to fine particles with a coffee grinder before analysis. The ergosterol content of the cell walls samples were subsequently determined using sample preparation and extraction protocols adapted from Dimartino (2007) and Huang et al., (2009).

TABLE 1
Dry matter balance during fractionation of regular baker's yeast
S. cerevisiae
(LYCC* 6939)

| | |
|---|---|
| Weight of yeast cream (g) | 6000 |
| Solids of yeast cream (%) | 14.99 |
| Weight of dry yeast (g) | 899 |
| Weight of hydrolysate after hydrolysis and inactivation (g) | 6006 |
| Solids of hydrolysate after hydrolysis and inactivation (%) | 14.11 |
| Weight of liquid cell walls produced (g) | 2264 |
| Solids of liquid cell walls produced (%) | 17.18 |
| Weight of dry yeast cell walls (g) | 369 |
| Yield of yeast cell walls (%) | 43.25 |
| Weight of dry yeast extract (g) | 510 |
| Yield of yeast extract (%) | 56.75 |

(*Lallemand Yeast Culture Collection).

The results of the dry matter balance analysis during the fractionation experiments with the regular baker's yeast are presented in Table 1. From 6000 g of liquid yeast with 14.99% solids, 2264 g of liquid cell walls were produced. Based on the solids contents of the liquid cell walls, which was determined to be 17.18%, the dry matter of the yeast cell walls produced would be 369 g. The yields achieved for the cell walls and yeast extract were 43.25% and 56.75%, respectively. Both yields are similar to what are achieved in commercial yeast extract production with Saccharomyces cerevisiae.

TABLE 2
Ergosterol content in starting yeast and yeast cell walls fraction.
S. cerevisiae
(LYCC 6939)

| | |
|---|---|
| Ergosterol content of dry yeast @95% | 0.704% |
| Ergosterol content of dry yeast cell walls @95% | 1.603% |
| % increase in ergosterol content in cell walls | 127.7% |

As shown in Table 2, ergosterol contents for the starting yeast and the cell walls fraction produced were determined to be 0.704% and 1.603%, respectively. Therefore, the ergosterol content of the cell wall was about 2.3 times higher than that of the starting yeast.

TABLE 3
Ergosterol mass balance analysis during fractionation.
S. cerevisiae
(LYCC 6939)

| | |
|---|---|
| Weight of liquid yeast (g) | 6000 |
| Solids of liquid yeast (%) | 14.99 |
| eight of dry yeast (g) | 899 |
| Weight of dry yeast @95% | 946 |
| Ergosterol content of dry yeast @95% (%) | 0.704 |
| Total ergosterol in yeast (g) | 6.66 |
| Weight of dry yeast cell walls (g) | 369 |
| Weight of dry yeast cell walls @95% (g) | 409 |
| Ergosterol content of dry yeast cell walls @95% (%) | 1.603 |
| Total ergosterol in cell walls fraction (g) | 6.56 |
| Ergosterol recovery efficiency in cell walls (%) | 98.56 |

Ergosterol mass balance analysis during the yeast fractionation experiments is illustrated in Table 3. Ergosterol recovery efficiency in the cell walls fraction was very close to 100%. The ergosterol recovered in the cell walls fraction accounted for 98.56% of the total ergosterol from the starting yeast, indicating predominant partition of ergosterol into the cell walls fraction during the yeast autolysis and fractionation process. As a result, dramatic enrichment of ergosterol in cell walls fraction was achieved during the yeast extract production process.

### Example 2

### UV Treatment of Liquid Yeast Cell Walls in a Surface Photo-Bioreactor

The liquid yeast cell walls (from Saccharomyces cerevisiae) were prepared similarly to the protocol in Example 1. The dry matter content of the liquid cell walls obtained was adjusted to 11% before UV treatment.

According to the process presented in FIG. 3, liquid yeast cell walls were UV treated using a surface ultraviolet photo-bioreactor as illustrated in FIG. 1. The center of the photo-bioreactor setup was the 8W UV lamp from UVP with three switchable UV tubes: short-range (254 nm), mid-range (302 nm) and long-range (365 nm). Since the liquid yeast walls are nearly opaque to ultraviolet rays, it was necessary to stir the yeast cell walls during treatment so that all the molecules of ergosterol would reach the surface of the solution for ultraviolet irradiation. The surface photo-bioreactor was used to achieve a thin layer of liquid yeast cell walls and increase the efficiency of vitamin D2 conversion. 120 mL liquid yeast cell walls were loaded in the rectangular container and continuously irradiated for 4 hours. During treatment, the liquid cell walls were mixed continuously. The experiments were conducted at 4° C. and 50° C. and the photoreaction was conducted at a UV wavelength of 254 nm (UVC) for each temperature.

Following treatment, dry cell walls samples were prepared. The liquid cell walls fraction was filtered or centrifuged and pressed to make a cell walls cake. The cell walls cake was then dried in the oven at 85° C. for 4-5 hours and further grounded to fine particles with a coffee breaker before analysis. The dry yeast cell walls samples were sent to Covance Laboratories Inc. (Madison, Wisconsin) for HPLC vitamin D2 analysis using official method 982.29 (Official Methods of Analysis of AOAC INTERNATIONAL (2000) 17^{th} Ed., AOAC INTERNATIONAL, Gaithersburg, Md., USA).

TABLE 4
Vitamin D2 content of yeast cell walls following treatment
with UV light in a surface photo-bioreactor at 254 nm.

| | Vitamin D2 Content |
|---|---|
| Sample | (IU/100 g) |
| LYCC 6939 Control cell walls | 5570 |
| LYCC 6939 Vitamin D2 cell walls produced at | 3'910'000 |
| 4° C. | |
| LYCC 6939 Vitamin D2 cell walls produced at | 5'800'000 |
| 50° C. | |

As shown in Table 4, the vitamin D2 content in the control cell wall was determined to be 5570 IU/100 g. This was because the commercial cream yeast used to produce the cell wall was obtained from plant, which contained about 3778 IU/100 g of vitamin D2 (on dry matter basis). For the vitamin D yeast cell wall sample produced at 4° C., the vitamin D2 content was 3,910,000 IU/100 g (on dry cell wall basis) which represents an increase of 702 times compared to the control cell wall. At a temperature of 50° C., the vitamin D2 content was 5′800′000 IU/100 g (on dry cell wall basis) which represents an increase of 1041 times. Therefore, the vitamin D2 content of liquid yeast cell wall can be dramatically increased after ultraviolet treatment at 254 nm, especially at a temperature of 50° C.

### Example 3

### UV Treatment of Liquid Yeast Cell Walls in a Submerged Photo-Bioreactor

According to the process presented in FIG. 3, liquid yeast cell walls (produced in accordance with Example 1 from Saccharomyces cerevisiae) was UV treated with a submerged ultraviolet photo-bioreactor as illustrated in FIG. 2. The liquid cell walls was prepared according to Example 1 and 18 liters of liquid yeast cell walls with a solid content of 10% was loaded in a 20 liters photo-bioreactor equipped with a 14 Watts ultraviolet lamp with a wavelength of 254 nm (UVC) from Atlantic Ultraviolet Corporation. Vigorous agitation was provided with an agitator to ensure the UV treatment of the entire volume and maintain high transmission of UV rays by preventing potential fouling around the quartz sleeve. The 18 liters of liquid cell walls was continuously mixed and UV treated for 72 hours at 4° C.

As shown in FIG. 5, the vitamin D2 content in cell walls increased from 6590 to 3′180′000 IU/100 g in 72 hours, which represents an increase of about 485 times. Although the vitamin D2 content achieved is lower than the surface photo-bioreactor due to a larger volume, the time course indicates higher quantities of vitamin D2 could be obtained for longer treatment periods. The production of UV treated yeast cell walls comprising vitamin D2 by UV treatment of liquid yeast cell walls is therefore compatible with both surface and submerged photo-bioreactors.

### Example 4

### Effect of UV Wavelength on the Increase of Vitamin D2 in Yeast Cell

Liquid yeast cell walls were produced according to Example 1 from Saccharomyces cerevisiae. UV treatment of the liquid yeast cell walls was carried out using the same surface photo-bioreactor as described in Example 2 using three different wavelengths: 254 nm (UVC), 302 nm (UVB) and 365 nm (UVA). The UV treatment was performed during 2 hours and all experiments were conducted at room temperature. Four UV treated dry yeast cell walls samples (three treated and one control) were produced and sent to Covance for vitamin D2 analysis as described in Example 2.

TABLE 5
Effect of UV wavelength on the increase of vitamin D2 in yeast cell
walls following UV treatment in a surface photo-bioreactor.

| | Yeast Format | |
|---|---|---|
| | Vitamin D2 Content | Times of Vitamin D2 |
| | in UV-Treated Yeast | Enrichment relative |
| | Cell Walls | to Control |
| 254 nm | 624'000 IU/100 g | 95 |
| 302 nm | 1'230'000 IU/100 g | 186.9 |
| 365 nm | 7'670 IU/100 g | 1.2 |
| Control Cell Walls (before | 6'580 IU 100 g | |
| irradiation) | | |

As shown in Table 5, the UV wavelength selected strongly influences the vitamin D2 increase in the yeast cell walls fraction. Although UVA was not effective in converting ergosterol into vitamin D2 in liquid yeast cell walls, a wavelength of 302 nm (UVB) was found to be significantly more effective than 254 nm (UVC).

### Example 5

### UV Treatment of Liquid Yeast Cell Walls From a Non-Saccharomyces Yeast in a Surface Photo-Bioreactor

UV treatment effectively increases the vitamin D2 content of a non-Saccharomyces yeast cell walls, ultraviolet treatment of the liquid yeast cell wall made from Torula was carried out according to the protocol described in Example 2. UV treatments were made at 254 nm for four hours and two temperatures (4 and 50° C.).

TABLE 6
Vitamin D2 content of UV treated Torula yeast cell walls at
254 nm in a surface photo-bioreactor.

| | Vitamin D2 Content |
|---|---|
| Samples | (IU/100 g) |
| Torula yeast control cell walls (before UV | 0 |
| treatment) | |
| UV treated Torula yeast cell walls comprising | 1'330'000 |
| vitamin D2 produced at 4° C. | |
| UV treated Torula yeast cell walls comprising | 1'780'000 |
| vitamin D2 produced at 50° C. | |

Since the Torula yeast cream was produced in the laboratory, no vitamin D2 was detected in the control Torula yeast cell walls. Similar to Saccharomyces cerevisiae yeast cell walls, the vitamin D2 content of Torula yeast cell walls was increased dramatically through ultraviolet treatment, with an increase from non-detectable to 1′330′000 IU/100 g at 4° C. (on dry cell wall basis) and from non-detectable to 1′780′000 IU/100 g at 50° C. (on dry cell wall basis). In addition, higher vitamin D2 content was observed at high photoreaction temperature (50° C.), which was consistent with previous observations in UV treated yeast cell walls from Saccharomyces cerevisiae.

### Example 6

### Production of UV Treated Yeast Cell Walls Comprising Vitamin D2 Through Autolysis and Fractionation of UV Treated Yeast Comprising Vitamin D2—Pilot Trial

According to the process described in FIG. 4, UV treated yeast cell walls comprising vitamin D2 was produced by UV treating commercially-produced liquid yeast increase the vitamin D2 content. The resulting UV treated liquid yeast was then subjected to a typical yeast extract production processes resulting in UV treated yeast extract and UV treated yeast cell walls (by-product). Treatment was performed in a full-scale submerged photo-bioreactor system as shown in FIG. 2. The UV treated liquid yeast comprising vitamin D2 was further processed into UV treated CONCENTRATE Instant Dry Yeast (IDY) comprising vitamin D2 (about 95% solids) by using a fluid bed dryer.

The pilot UV treated yeast comprising vitamin D2 fractionation experiment was conducted in a 75 liters Chemap fermenter (total volume 75 L) with the UV treated CONCENTRATE IDY comprising vitamin D2. 10 kg of UV treated CONCENTRATE IDY comprising vitamin D2 (with vitamin D2 content of 2′700′000 IU /100 g) was blended with 50 kg of tap water to make a cream yeast with a solid content of approximately 16%. 20 g of antifoam was added to the solution. Papain (Promod 144GL from Biocatalysis) was added at a dosage of 0.5% based on yeast dry matter. The yeast cream was hydrolyzed for 22 h at 56° C. at a pH of 5.5-5.8 with an agitation rate of 600 rotations per minute (rpm). The resulting hydrolysate was then inactivated by heat treatment at 80° C. for 60 minutes. Following cooling, separation was conducted using a centrifuge to wash and harvest the UV treated yeast cell walls comprising vitamin D2 and UV treated yeast comprising vitamin D2 extract fractions. Spray-drying of the final cell wall fraction was then conducted to produce the final UV treated dry yeast cell walls comprising vitamin D2.

TABLE 7
Yields of UV treated yeast extract comprising vitamin D2 and
UV treated yeast cell walls fraction comprising vitamin D2 during
the pilot UV treated yeast comprising vitamin D2 fractionation.

| 10 kg UV treated CONCENTRATE comprising | 60 kg |
|---|---|
| vitamin D2 @95% solids + 50 kg water = initial | |
| yeast cream | |
| Yeast cream after 22 hrs hydrolysis and 30 minutes | 58 kg |
| inactivation | |
| Cell walls fraction (dry matter) | 4.53 kg |
| Yeast extract fraction (dry matter) | 4.94 kg |
| Total (yeast extract + cell walls) (dry matter) | 9.47 kg |
| Yield of yeast cell walls (with 1 washing) | 47.84% |
| Yield of yeast extract (with 1 washing) | 52.16% |

TABLE 8
Mass balance of he spray-dried sample following fractionation
of UV treated yeast comprising vitamin D2.

| | Weight | Vitamin D2 | Total | Mass |
|---|---|---|---|---|
| | (dry matter) | content | Vitamin | balance |
| Sample | (kg) | (IU/100g) | D2 (IU) | (%) |
| UV treated | 9.50 | 2'840'000 | 270000000 | 100% |
| CONCENTRATE | | | | |
| UV treated Cell | 4.53 | 5'360'000 | 243000000 | 90% |
| Walls (CW) | | | | |
| comprising vitamin | | | | |
| D2 | | | | |
| UV treated Yeast | 4.94 | 214'000 | 10600000 | 4% |
| Extract (YE) | | | | |
| comprising vitamin | | | | |
| D2 | | | | |
| Total (CW + YE) | 9.47 | | 253600000 | 94% |

As shown in Table 7, from 10 kg of UV treated CONCENTRATE IDY, comprising vitamin D2 4.53 kg of UV treated dry yeast cell walls comprising vitamin D2 and 4.94 kg of UV treated dry yeast extract comprising vitamin D2 were produced. The yields of the UV treated yeast cell walls comprising vitamin D2 and the UV treated yeast extract comprising vitamin D2 were 47.84 and 52.76%, respectively.

The vitamin D2 contents of the UV treated dry yeast cell wall and UV treated dry yeast extract were determined to be 5′360′000 and 214′000 IU/100 g, respectively. The vitamin D2 content in the UV treated yeast cell fraction produced was 1.88-fold higher than the vitamin D2 content in the UV treated concentrate IDY. Table 8 also demonstrates that vitamin D2 is predominantly partitioned in the UV treated yeast cell walls fraction during the UV treated yeast extraction process from a UV treated concentrate IDY (90%) comprising vitamin D2, consistent with the previous finding that ergosterol was also predominantly partitioned in the yeast cell walls fraction.

### Example 7

### Production of UV Treated Yeast Cell Walls Comprising Vitamin D2 Through Autolysis and Fractionation of UV Treated Yeast Comprising Vitamin D2—Commercial Trial

For the commercial trial, a 1500 liters fermenter was used. The starting UV treated liquid yeast comprising vitamin D2 was produced according to Example 6. The solid and vitamin D2 content of the starting UV treated yeast solution were determined to be 17.84% and 2′560′000 IU/100 g (on dry yeast basis) respectively. 1300 liters of the UV treated liquid yeast comprising vitamin D2 was hydrolyzed in the fermenter for 22 h at 55° C., at a pH of 5.5 with agitation of 300 rpm. Besides the mechanical foam breaker, 500m1 of antifoam was also added. Papain (Promod 144GL from Biocatalysis) was added at a dosage of 0.5% based on yeast dry matter. After hydrolysis, the hydrolysate was then inactivated by heat treatment at 75° C. for 30 min. Following cooling, separation was conducted using a BTPX205 separator (Alfa Laval Inc.) to harvest the yeast cell walls fraction.

TABLE 9
Mass balance of the spray-dried sample following fractionation
of UV treated yeast comprising vitamin D2.

| | Weight | | Vitamin | Total | |
|---|---|---|---|---|---|
| | @ 95% | | D2 | Vitamin | Mass |
| | solids | Yield | content | D2 | balance |
| Sample | (kg) | (%) | (IU/100 g) | (IU) | (%) |
| UV treated liquid | 260 | | 2'560'000 | 6656 × 10⁶ | 100% |
| yeast comprising | | | | | |
| vitamin D (1300 | | | | | |
| L Cream @ | | | | | |
| 17.84%) | | | | | |
| Cell Walls (CW) | 127 | 48.85 | 4'980'000 | 6325 × 10⁶ | 95.0% |
| Yeast Extract | 133 | 51.15 | 130'000 | 173 × 10⁶ | 2.6 |
| (YE) | | | | | |
| Total (CW + YE) | 260 | 100 | | 6498 × 10⁶ | 97.6% |

From 1300 liters of UV treated liquid yeast comprising vitamin D2 (at 17.84% dry matter content) or 260 kg of UV treated dry yeast (at 95% dry matter content), 127 kg of dry cell walls and 133 kg of dry yeast extract were produced. The yields of the yeast cells wall and the yeast extract were 48.75 and 51.15%, respectively. The vitamin D2 content in the yeast cells wall was determined to be 4′980′000 IU/100 g, which was 1.94-fold higher than the vitamin D2 content in the starting UV treated liquid yeast comprising vitamin D (2′560′000 IU/100 g). The vitamin D2 content in the yeast extract fraction was only 130′000 IU/100 g. Therefore, commercial levels of yeast cells wall comprising vitamin D2 can be produced with a potentially higher content of vitamin D2 than what can be found in yeast comprising vitamin D2.

### Example 8

### Effect of UV Treated Yeast Cell Walls Comprising Vitamin D2 Supplementation in the Diet of Layer Chickens on the Vitamin D2 Content of Egg Yolk

One hundred and twenty-six, 39 week-old egg producing layers (Shaver) were randomly assigned to 7 dietary treatments over a 10-week experimental period at McGill University (Montreal, Canada). All birds were housed in cages (6 cage replicates per treatment; n=3 birds/cage) and raised under controlled conditions at a temperature of 22.0° C. and 15 hours of lightning per day. The following 7 dietary treatments were examined: Diet 1=Vitamin D-free diet (−CTL, negative control); Diet 2=Diet 1+vitamin D inactivated yeast (2,500 IU/kg); Diet 3=Diet 1+vitamin D inactivated yeast (15,000 IU/kg); Diet 4=Diet 1+UV treated yeast cell walls comprising vitamin D (2,500 IU/kg); Diet 5=Diet 1+UV treated yeast cell walls comprising vitamin D (15,000 IU/kg).

All birds were fed a vitamin-free diet supplemented with 2,500 kg IU/kg of vitamin D3 prior treatment. Samples were collected after an adaptation period of two weeks. Feed and water were provided ad libitum.

Eggs were collected and weighted daily. Birds live weight and feed intake were measured on a per cage basis at a 2-week time interval. Two eggs per cage (n=12/treatment) were collected every two weeks for measurements of egg shell strength. Another set of eggs was collected at the same time for the evaluation of the vitamin D content of egg yolks. Blood samples were also collected (n=6 per treatment) for serum vitamin D analysis. Vitamin D3 and D2 contents in egg yolk samples were analyzed by Heartland Assays at Ames, Iowa. The blood serum samples were sent to Intelimmune LLC Inc. at West Lafayette, Indiana for 25-(OH.) D2 and 25-(OH) D3 analysis using a LC/MS/MRM method.

At the end of the trial, 10 birds per dietary treatments were euthanized by bleeding of the carotid artery and tibia of respective birds was collected for measurements of tibia length, diameter and breaking strength. Egg shell and tibia breaking strength were measured as compressive fracture force using a tensiometer (Instron Model 4500, MA, USA) fitted with a 500-N load cell.

Based on the collected data for body weight, feed intake, feed conversion, egg production rate, egg weight, egg diameter and egg shell breaking strength during the trials (data not shown), no significant effects were observed among the 5 diets tested.

The highest vitamin D2 content in egg yolk was achieved with the diet containing UV treated yeast cell walls comprising 15′000 IU/kg of vitamin D2 (Diet 5), in which the vitamin D2 content in egg yolk was 422 IU/100 g after 6 weeks. The vitamin D2 level on a whole-egg basis would be 146 IU/100 g (a division of the egg yolk result by a factor of 2.9: see Mattila et al., 2004). As per egg basis (assuming egg weight=60 g), the highest vitamin D2 content per egg achieved was about 87.6 IU/egg, which would represent 175.2 IU of vitamin D2 intake per day (or 44.4% RDA) if one eats 2 eggs daily. The study successfully demonstrated that yeast cell walls comprising vitamin D2 can be used to supplement diets of layer chickens for enhancing the vitamin D2 content in eggs.

While the invention has been described in connection with specific embodiments thereof, it will be understood that it is capable of further modifications and this application is intended to cover any variations, uses, or adaptations of the invention following, in general, the principles of the invention and including such departures from the present disclosure that come within known or customary practice within the art to which the invention pertains and as may be applied to the essential features hereinbefore set forth, and as follows in the scope of the appended claims.

1. UV treated isolated yeast cell walls comprising vitamin D2.

2. The UV treated isolated yeast cell walls according to claim 1, wherein the yeast is from the genus Saccharomyces or any non-Saccharomyces yeast.

3. The UV treated isolated yeast cell walls according to claim 2, wherein the non-Saccharomyces yeast is selected from the group consisting of Candida sp, Hanseniaspora sp, Hansenula sp, Kluyveromyces sp, Metschnikowia sp, Pichia sp, Starme relict sp and Torulaspora sp.

4. The UV treated isolated yeast cell walls according to claim 3, wherein the yeast is Saccharomyces cerevisae or Cyberlindnera jadinii (Torula yeast),

5-6. (canceled)

7. The UV treated isolated yeast cell walls according to claim 1, wherein the UV treated isolated yeast cell walls comprise β-glucan.

8. The UV treated isolated yeast cell walls according to claim 7, wherein the β-glucan content is at least 75%, preferably 80%, more preferably 85%, most preferably 90% of the β-glucan content of yeast cell walls untreated with UV.

9. Use of UV treated isolated yeast cell walls as defined in claim 1 as a dietary supplement for animal or human nutrition.

10. Use of UV treated isolated yeast cell walls as defined in claim 1 as additives for baked goods, functional food, dietary food, nutritional food, fermented or non-fermented beverage.

11. A baked good produced using UV treated isolated yeast cell walls as defined in claim 1.

12. The baked good according to claim 11, wherein the baked good is bread, crackers, sport bars or biscuits.

13. A composition comprising an animal feed and UV treated isolated yeast cell walls as defined in claim 1.

14. The composition according to claim 13 for use in the diet of layer chickens to increase vitamin D2 content in egg yolk.

15. The composition according to claim 13 for use in the diet of animals as a dietary supplement.

16. A method of increasing vitamin D2 content in egg yolk comprising feeding a composition comprising a layer chickens feed and UV treated isolated yeast cell walls comprising vitamin D2 to layer chickens.

17-23. (canceled)
